(19) United States
(12) Patent Application Publication
(10) Pub. No.: US 2026/0220561 A1
(43) Pub. Date: Jul. 30, 2026

(54) INFORMATION MANAGEMENT DEVICE, INFORMATION MANAGEMENT METHOD, AND INFORMATION MANAGEMENT PROGRAM

(71) Applicant: BABIECA LLC, Tokyo (JP)

(72) Inventors: Tetsuya HIRATA, Tokyo (JP); Noriyuki ABE, Tokyo (JP); Daisuke KAMIYAMA, Tokyo (JP)

(21) Appl. No.: 19/120,964

(22) PCT Filed: Oct. 18, 2023
(86) PCT No.: PCT/JP2023/037697

§ 371 Date: Apr. 8, 2026

(30) Foreign Application Priority Data
Oct. 22, 2022 (JP) 2022-169539

(51) Int. Cl. G06Q 10/0631

(52) U.S. Cl. CPC G06Q 10/0631

(57) ABSTRACT

An information management device includes an encoding unit configured to encode item information, context information, instruction information, dependency constraint information, and mutual relationship information, and a calculation unit configured to calculate solutions of configurations based on the encoded mutual relationship information using propositional logic expressions. The item information identifies items, the context information identifies processes that change items from one state to another, and the instruction information relates to instructions or approvals for executing or modifying items and/or processes. The dependency constraint information specifies configurations and relationships among the item information, context information, and instruction information, and the mutual relationship information represents relationships determined based on the dependency constraint information.

### TECHNICAL FIELD

The present invention relates to an information management device, an information management method, and an information management program that manage information related to product specifications and operational processes in an integrated manner throughout a product lifecycle, from design and manufacturing to sales, including after-sales services, in the manufacturing industry.

### BACKGROUND ART

Conventionally, computer-based software tools such as CAD (Computer-Aided Design) and CAE (Computer-Aided Engineering) have been widely used in various phases of product development, including design, manufacturing, and sales, particularly in the manufacturing industry.

For example, Patent Document 1 discloses technologies related to production planning, while Patent Document 2 discloses technologies related to traceability of information associated with product manufacturing.

The planning system described in Patent Document 1 includes:
a planning device configured to generate a plurality of planning candidates and associated planning data based on specification information regarding a plurality of elements for identifying specifications of a plan, and constraint information specifying constraints for each of the plurality of elements;
a planning evaluation device configured to evaluate each piece of planning data and generate a plurality of pieces of evaluation data;
an evaluation input device configured to transmit the planning data generated by the planning device to a user terminal, and to receive user data indicating evaluation results for each piece of planning data from the user terminal; and
an evaluation learning device configured to learn the user evaluation results received by the evaluation input device as learning data, and to construct an evaluation model for each planning candidate based on the learning results.

The traceability method described in Patent Document 2 includes:
an assembly process of assembling pre-processed components to form an assembled unit;
a storage process of storing the assembled unit by placing one or more assembled units on a trolley cart; and
a finished product assembly process of assembling the pre-processed components stored in the storage process to form a finished product,
wherein:
the assembly process further includes a recording process of generating an assembly slip in which the pre-processed components used and a trolley cart number for each assembled unit are recorded; and
the finished product assembly process further includes a recording process of generating a finished product slip in which the trolley cart numbers are recorded.

### PRIOR ART DOCUMENTS

### Patent Documents

Patent Document 1: JP 2020-201611 A
Patent Document 2: JP 2018-22208 A

### SUMMARY OF THE INVENTION

### Problems to be Solved by the Invention

The technology described in Patent Document 1 selects plans having high predictive accuracy by using an evaluation learning device trained on user evaluation results for planning data based on specification information and constraint information.

However, this technology does not support integrated configuration management covering operational processes from product design to sales and beyond.

In other words, planning data having high predictive accuracy cannot be appropriately generated for all stakeholders without taking into account information such as instructions or approvals for execution or modification of multiple elements constituting the specification information, including delivery dates, product types, production timing, and costs.

Accordingly, satisfactory integrated configuration management cannot be achieved.

The technology described in Patent Document 2 enables traceability for each product by treating an assembly slip as first traceability information and a finished product slip as second traceability information, even when an assembly process of an assembled unit and an assembly process of a finished product are not synchronized.

However, this technology does not disclose or suggest information such as instructions or approvals for execution or modification of delivery dates, product types, production timing, and costs. Therefore, even when combined with the technology of Patent Document 1, it is difficult to achieve integrated configuration management across operations from product design to sales and beyond.

Configuration management refers to the management of elements necessary for providing services using information technology (IT).

These elements include, for example, organizational structures and personnel; documents such as drawings, specifications, instructions, and purchase orders; hardware and software constituting systems, and licenses thereof; as well as the handling of incidents and problems.

Configuration management is essential for managing incidents, problems, changes, and releases in the provision of such services. Therefore, it is effective to manage information relating to these elements as configuration items (CIs).

Additionally, without taking into account information such as instructions or approvals for execution or modification of the above-described multiple elements that can relax constraints, there is a risk that certain constraints may become excessively strict.

When setting constraints, it is necessary to consider not only inorganic information (i.e., time- or sequence-independent information) such as specifications, but also organic information (i.e., time- or sequence-dependent information) including sequences and timing.

In other words, by combining inorganic information with organic information, constraints can be flexibly tightened or relaxed to obtain desired solutions.

Furthermore, organic information can be modified without changing the inorganic information, thereby enabling constraints to be adjusted as needed.

Hereinafter, a conventional information management method in manufacturing will be described with reference to FIG. 15.

As shown in FIG. 15, prior to selling products or components, multiple lists managing the above-described documents, which reflect requirements of respective departments and personnel at each phase (i.e., complex requirements), are aggregated into a single list according to organizational rules.

This aggregated list is then provided to a subsequent phase, and is handled together with multiple lists generated in that phase.

In other words, in each phase, complex requirements, including those from a previous phase, are consolidated into a single result, and approvals and modifications are applied to these requirements as necessary in accordance with actual conditions.

Therefore, in each phase, it is difficult for departments and personnel to accurately understand requirements from a previous phase. As a result, approvals or disapprovals of such requirements, the existence and scope of changes, and the timing of such actions must be determined based solely on the provided list.

Additionally, in each phase, departments and personnel merely list their respective requirements, making it difficult to understand approvals or disapprovals, the existence and scope of changes, and the timing of such actions.

In other words, it is difficult to track when, where, by whom, and to what extent the requirements of departments and personnel in each phase are reflected in a final product. That is, traceability is unclear.

For example, when a defect is found in a component assembled into a finished product, the following four activities are required in order to identify a root cause of the defect:
(1) verifying appropriateness of requirements defined by a department or personnel in an initial design phase for the component;
(2) verifying appropriateness of a consolidated result including the requirements;
(3) verifying how the consolidated result is reflected in a subsequent phase; and
(4) verifying appropriateness of an aggregated result based on the reflection status.

Moreover, these activities must be performed sequentially from an upstream phase to a downstream phase; otherwise, the root cause cannot be identified.

In other words, it is necessary to verify appropriateness of each process in each phase in a reverse order from the downstream phase to the upstream phase, including verification of recent requirements relating to the component in a sales phase, including after-sales service.

Therefore, under a conventional system, identifying a root cause of a defect in a component is extremely inefficient.

Furthermore, a root cause of a defect in the above-described component may lie not only in specifications of the component itself but also in operations, including handling processes at each phase through which the component has passed.

In other words, in order to obtain a single optimal solution (i.e., a result), it is essential to incorporate, as constraints, not only information relating to products and components but also information such as approvals or disapprovals of requirements, the existence and scope of changes, and timing of such actions.

If a solution is not both optimal and singular, accuracy of traceability cannot be ensured, thereby making reverse traceability impossible.

A single optimal solution can be obtained by including selectable items and items that may occur in each phase.

These items include, in a design phase, requirements for specifications such as design, color, functionality, and materials of a component, together with approvals or disapprovals of such requirements, the existence and scope of changes, and timing of such actions; and, in a manufacturing phase, requirements for operations such as arrangement, layout, and coordination for manufacturing the component, together with approvals or disapprovals of such requirements, the existence and scope of changes, and timing of such actions.

Conventional management numbers assigned to products or components are typically defined according to organization-specific rules and tend to have complex structures.

For example, such management numbers may include combinations of digits, letters, or symbols representing various elements, such as:
drawings (e.g., assembly, system, structure, specifications, tolerance, machining, piping and wiring, line, item, jig, relationship, process);
functions and configurations (e.g., parent-child relationships);
classifications (e.g., prototype, mass production);
completion levels (e.g., finished product, semi-finished product);
specifications (e.g., single item, combined);
destinations (e.g., Japan-bound, USA-bound, Europe-bound);
change management (e.g., initial change, first revision); and
planning levels (e.g., regular prototype, temporary prototype, provisional drawing).

In summary, such management numbers are generated by combining one or more digits, letters, or symbols to represent requirements of each phase or department, thereby mixing elements having predefined meanings with elements having no specific meanings.

In particular, when elements having predefined meanings are frequently used, available combinations of numbers, letters, and symbols for assignment may be exhausted.

If additional meanings are introduced, management numbers become more complex, which may lead to discrepancies between management numbers and actual items, or to misunderstandings of such meanings among different departments or personnel.

On the other hand, prioritizing elements without predefined meanings may result in loss of consistency in interpretation of meanings based on combinations of elements, thereby making communication among departments or personnel difficult.

Accordingly, in order to resolve the above-described issues in management numbering, it is desirable to clearly define elements having specific meanings and elements having no specific meanings, and to standardize assignment of such elements according to explicit rules.

In order to address the above-described issues, a first object of the present invention is to provide an information management device, an information management method, and an information management program that enable integrated configuration management across various phases and operational processes for items, including products and components, and that achieve high-precision bidirectional traceability.

A second object of the present invention is to provide an information management device, an information management method, and an information management program that optimize combinations including requirements for item specifications, requirements for processes for realizing the item specifications, and information relating to approvals or disapprovals of such requirements, the existence and scope of changes, and timing of such actions (hereinafter also referred to as “instruction information”).

A third object of the present invention is to provide an information management device, an information management method, and an information management program that enable systematic organization of management numbers based on combinations of items, context, and instruction information.

### Means for Solving the Problems

The information management device according to the present invention comprises:
an encoding unit configured to encode various types of information; and
a calculation unit configured to calculate solutions based on the encoded information,
wherein the encoding unit comprises:
a first encoding unit configured to encode item information for identifying items;
a second encoding unit configured to encode context information for identifying processes that change items from a predetermined state to another state;
a third encoding unit configured to encode instruction information relating to instructions or approvals for executing or modifying items and/or processes;
a fourth encoding unit configured to encode dependency constraint information specifying configurations among item information, among context information, among instruction information, between item information and context information, between item information and instruction information, and between context information and instruction information; and
a fifth encoding unit configured to encode mutual relationship information representing relationships among item information, among context information, among instruction information, between item information and context information, between item information and instruction information, and between context information and instruction information, the relationships being determined based on the dependency constraint information,
wherein the calculation unit is configured to calculate configuration solutions by solving a combination problem based on the encoded information using propositional logic expressions.

With this configuration, as shown in FIG. 1, an optimal configuration solution can be obtained by calculating various types of information encoded using propositional logic expressions.

The encoded information includes item information, context information, instruction information, dependency constraint information, and mutual relationship information, thereby reflecting complex requirements.

The mutual relationship information is determined based on the dependency constraint information, which specifies configurations among item information, context information, and instruction information, as well as relationships among these elements.

Furthermore, by aggregating complex requirements of a current phase and providing both the optimal solution and alternative configuration solutions to a subsequent phase, it becomes possible to retrospectively evaluate suitability of the instruction information and quality of results in a previous phase. This is effective even when modification requests are included as instruction information in the complex requirements of the subsequent phase together with new requests.

In addition, by providing the system as a common tool for each phase, cross-phase management of item information, context information, and instruction information is facilitated, thereby enabling more efficient and horizontally integrated management.

According to the present invention, dynamic management of operational states in each phase, such as ECM (Engineering Chain Management) and SCM (Supply Chain Management), can be achieved, together with integrated configuration management covering processes from design to sales and beyond.

For example, management of incidents, issues, changes, and releases corresponding to provision of items can be performed.

Furthermore, by associating inorganic (abstract) item information and context information with organic (specific) instruction information, constraints for mutual relationship information can be flexibly set, thereby allowing such constraints to be tightened or relaxed as needed.

In addition, instruction information can be modified without changing the item information or the context information, thereby enabling flexible adjustment of constraints.

Moreover, constraint conditions can be made more or less stringent by defining relationships between inorganic item or context information and corresponding organic instruction information. Such flexibility further enables adjustment of constraint strictness through redefinition of the organic instruction information.

Furthermore, appropriateness of each process performed in each phase can be retrospectively evaluated in reverse order from a downstream phase to an upstream phase when investigating causes of defects in items identified in a specific phase.

For example, instructions relating to an item in a preceding phase can be examined, thereby facilitating efficient root cause analysis.

In addition, a single optimal solution can be obtained in each phase by incorporating, into combinations among item information, context information, and instruction information and relationships among these elements, elements that are selectable or that may occur in each phase, including instruction information relating to the item information and the context information.

Furthermore, by standardizing a numbering system according to predefined rules, management numbers can effectively convey requirements of departments and personnel in each phase, while enabling implementation of a simplified numbering system.

For example, such management numbers include:
management numbers of item information for identifying items, reflecting functionality and application areas included in item specifications;
management numbers of context information that are not used for identifying items, based on application sequences and chronological timing for determining specific operations; and management numbers of instruction information that are not used for identifying items, based on sequences or chronological timing relating to instructions or approvals for executing or modifying such operations.

The following describes preferred embodiments included in the present invention.

Preferably, the instruction information includes sequence information indicating a predetermined sequence and/or chronological timing information specified by year, month, day, hour, minute, and second, for identifying item information and/or context information.

With this configuration, accuracy of solutions for configuration of item information and context information identified by the instruction information can be enhanced.

In addition, both upstream-to-downstream traceability and downstream-to-upstream traceability (i.e., bidirectional traceability) can be flexibly performed.

Preferably,
the item information includes item common identification information assigned for item management, and item non-common identification information assigned for item management and detailing the item common identification information;
the context information includes process common identification information assigned for process management, and process non-common identification information assigned for process management and detailing the process common identification information; and
the instruction information identifies the item non-common identification information and/or the process non-common identification information.

With this configuration, for example, item information can be encoded using a management number formed by a combination of item common identification information and item non-common identification information corresponding to a specified number.

Similarly, context information can be encoded using a management number formed by a combination of process common identification information and process non-common identification information corresponding to a specified number.

Furthermore, by associating the item non-common identification information and/or the process non-common identification information with instruction information corresponding to a specified number, more accurate management numbers can be obtained, thereby enhancing accuracy of solutions for configuration of the item information and the context information.

Preferably, the calculation unit is configured to calculate configuration solutions by treating the mutual relationship information as a combination problem.

With this configuration, since propositional logic expressions can be solved using well-known mathematical models, implementation and expansion can be easily achieved using general-purpose information processing devices such as computers, without relying on sophisticated centralized hardware.

Preferably, the information management device further comprises a visualization unit configured to visualize the encoded information.

The visualization unit is configured to present calculated solutions as lists of combinations for respective solutions.

With this configuration, patterns of solutions for configurations of item information, context information, and instruction information can be provided as lists for respective combinations, thereby enabling both optimal and non-optimal solutions to be shared between phases.

This facilitates requests for changes or modifications to such solutions, thereby enhancing accuracy of the solutions and facilitating the aforementioned bidirectional traceability.

Preferably, the information management device further comprises a visualization unit configured to visualize the encoded information.

The visualization unit comprises:
a first visualization unit configured to visualize the encoded item information using an item information model;
a second visualization unit configured to visualize the encoded context information using a context information model;
a third visualization unit configured to visualize the encoded instruction information using an instruction information model;
a fourth visualization unit configured to visualize the encoded dependency constraint information using a dependency constraint information model; and
a fifth visualization unit configured to visualize the encoded mutual relationship information using a mutual relationship information model.

With this configuration, item information models, context information models, instruction information models, and dependency constraint information models can be used to represent mutual relationship information models.

This improves usability and facilitates more efficient information management.

Desired functions of the visualization units are as follows:
the first visualization unit is configured to extract icons from a first group of icons including two types of icons and/or from a second group of icons including two or more types of icons different from the first group, and to visualize the item information model;
the second visualization unit is configured to extract icons from the first group of icons and/or the second group of icons, and to visualize the context information model; and
the third visualization unit is configured to extract icons from the first group of icons and/or the second group of icons, and to visualize the instruction information model.

According to these functions, for example, by defining two types of icons having different shapes among a plurality of icons as a first group, and two or more types of icons other than the first group as a second group, meanings of item information models, context information models, and instruction information models can be easily visually understood.

In addition, such a configuration facilitates generation of mutual relationship information models.

Furthermore, since the following inventions relate to methods and programs corresponding to the present invention and differ only in category, detailed descriptions of effects, meanings of terms used in describing the invention, and examples are omitted.

An information management method according to the present invention, performed by a computer, comprising:
encoding item information for identifying items;
encoding context information for identifying processes that change items from a predetermined state to another state;
encoding instruction information relating to instructions or approvals for executing or modifying items and/or processes;
encoding dependency constraint information specifying configurations among item information, among context information, among instruction information, between item information and context information, between item information and instruction information, and between context information and instruction information;
encoding mutual relationship information representing relationships among item information, among context information, among instruction information, between item information and context information, between item information and instruction information, and between context information and instruction information, the relationships being determined based on the dependency constraint information; and calculating configuration solutions by solving a combination problem based on the encoded information using propositional logic expressions.

An information management program according to the present invention, causing a computer to perform:
encoding item information for identifying items;
encoding context information for identifying processes that change items from a predetermined state to another state;
encoding instruction information relating to instructions or approvals for executing or modifying items and/or processes;
encoding dependency constraint information specifying configurations among item information, among context information, among instruction information, between item information and context information, between item information and instruction information, and between context information and instruction information;
encoding mutual relationship information representing relationships among item information, among context information, among instruction information, between item information and context information, between item information and instruction information, and between context information and instruction information, the relationships being determined based on the dependency constraint information; and
calculating configuration solutions by solving a combination problem based on the encoded information using propositional logic expressions.

To further clarify the present invention, meanings of terms and examples thereof will be described below.

“Encoding” refers to processing for digitizing or transforming information, such as specific strings, images, audio, and signals, into a format that can be processed by a computer.

Such processing includes electronic (digital) representation or conversion into other forms, and may also include representing the information in a schematic manner, for example, by modeling.

“Visualization” refers to processing for graphically representing encoded information using shapes, lines, symbols, or other graphical elements such as icons, and for presenting types (items), names, and attribute values of the information.

Examples of attribute values include price, rating, dimensions, weight, temperature, speed, and area.

Such processing can be performed using designated tools operable on a user's information processing terminal.

“Item” refers to hardware, software, or electronic data composed of predefined strings.

In the manufacturing industry, for hardware products, an item may include materials derived from specified raw materials, components produced from such materials, and finished products obtained by processing or assembling the components.

Furthermore, the item encompasses both products and components, as well as objects used therefor, including raw materials, materials, components, parts, programs, software packages, drawings, consumables, and jigs, over all or part of a process until the hardware is distributed in a market (hereinafter also referred to as a “flow”).

“Process” refers to an action of changing an item from one predetermined state to another state.

The process includes design processes and manufacturing processes for hardware, such as machining processes, molding processes, painting processes, assembly processes, and inspection processes (collectively referred to as “work”);
procedures necessary for establishing such design and manufacturing processes (referred to as “steps”);
actions required for such procedures (referred to as “tasks”);
paths indicating areas or organizations through which hardware is moved (referred to as “routes”); and
selections among two or more of hardware items, steps, tasks, or routes (referred to as “selections” or “choices”).

“Item information” refers to data for identifying items, and comprises item basic information including specifications such as name, shape, design, color, structure, dimensions, components, accuracy, functions, performance, grade, classification, and applied technology.

The item information further includes item common identification information for managing the item basic information, and item non-common identification information for providing more detailed management of the item basic information within the item common identification information.

“Item common identification information” refers to a number or symbol, expressed as a character string, representing a name or specifications of an item.

Such information may include, for example, function numbers, specification numbers associated with functions, measurement units, and regulations, and may be assigned to items other than products.

“Item non-common identification information” refers to a numerical or symbolic representation of an item's name, specifications, or a combination thereof. This may include component numbers, drawing numbers, and when combined with common item identification information, it enables the identification of the item. This type of information may be assigned to items other than physical products.

“Context information” refers to data for identifying processes, and includes:
process basic information including a process name and specifications;
process common identification information assigned for managing items or processes;
process non-common identification information assigned for more detailed management of items or processes within the process common identification information; and
non-common identification additional information added to item non-common identification information and/or process non-common identification information to further specify such information.

“Process common identification information” refers to numerical or symbolic information, expressed as a character string, representing names or specifications of work, steps, tasks, routes, selections, or a combination thereof.

For example, such information includes standard process numbers used to identify standard processes, as well as associated specification numbers, measurement units, and regulations.

“Process non-common identification information” refers to numerical or symbolic information, expressed as a character string, representing names or specifications of work, steps, tasks, routes, selections, or a combination thereof.

For example, such information includes application process numbers used to identify processes adjusted for use with standard processes (referred to as “application processes”)

Such information may enable identification of processes when combined with process common identification information.

In summary, item common identification information and process common identification information represent data that remains constant regardless of specific conditions, such as external environmental factors for identification including temperature and location of design or manufacturing.

In contrast, item non-common identification information and process non-common identification information represent data that varies depending on such specific conditions.

“Non-common identification additional information” refers to information relating to routes (referred to as “route information”) and information relating to selections (referred to as “selection information”).

The route information may be represented by a route name or by an alphanumeric code representing the route.

Similarly, the selection information may be represented by a selection name or by an alphanumeric code representing the selection.

“Instruction information” refers to information relating to instructions or approvals, and includes descriptions thereof or alphanumeric codes representing such instructions or approvals.

For example, such information includes engineering change numbers, approval numbers, and instruction numbers.

“Sequence information” included in instruction information refers to information relating to an arrangement required to bring items and/or processes from a predetermined state to a desired state.

Such information is also referred to as “arrangement information” hereinafter.

“Chronological timing information” (also referred to as time series information) included in instruction information refers to time information (year, month, day, hour, minute, and second) used to bring items and/or processes from a predetermined state to a desired state or to initiate instructions for items and/or processes.

Route information and selection information may constitute all or part of process information.

“Dependency constraint information” refers to data indicating configurations of relationships among item information, context information, and instruction information, as well as relationships between these elements.

For example, such information includes various types of relationships:
a “parallel relationship” in which one element is arranged in parallel with other elements;
a “dependency or requirement relationship” in which one element depends on or requires other elements;
a “selection relationship” in which one element selects one or more other elements;
a “mandatory relationship” in which one element mandates one or more other elements;
an “exclusive relationship” in which elements are mutually exclusive;
a “membership relationship” in which one element includes one or more other elements as members;
an “ownership relationship” in which one element owns one or more other elements;
a “sharing relationship” in which one element shares one or more other elements;
a “deriving relationship” in which one element derives one or more other elements; and
a “realization relationship” in which one element is realized by one or more other elements.

“Combination problem” refers to processing for generating combinations of elements in mutual relationship information corresponding to configurations among item information, context information, and instruction information, as well as relationships between these elements.

Such processing involves considering constraint information contributing to constraint satisfaction for the combinations and/or objective functions contributing to optimization.

The constraint satisfaction narrows down the combinations to obtain solutions based on the dependency constraint information.

The optimization further refines the solutions to obtain desired optimal solutions based on the constraint satisfaction.

Constraint information may be defined using an attribute value (individual value) or a calculated attribute value as a threshold, and may be set in any one of six ways: being within a specified numerical range, being greater than or equal to a specified numerical value, or being less than or equal to a specified numerical value.

An objective function may be defined in any one of three ways: to maximize, minimize, or achieve an extremum of calculated attribute values.

Constraint information and objective functions may be set for one or more attributes, and, when multiple objective functions are present, priorities may be assigned thereto.

Calculated attribute values refer to values obtained, for example, as a sum of attribute values of a plurality of elements or as a sum of two or more attribute values, and may be derived from arithmetic operations or other formulas.

Constraint information is set using attribute values or calculated attribute values as thresholds, and objective functions may be set to maximize, minimize, or achieve an extremum of the calculated attribute values.

Examples of mathematical models for solving propositional logic expressions include SAT (Satisfiability Problem), SMT (Satisfiability Modulo Theories), ASP (Answer Set Programming), SPIN (Simple Promela Interpreter), CTL (Computation Tree Logic), LTL (Linear Temporal Logic), ATP (Automated Theorem Proving), PA (Proof Assistant), PC (Proof Checker), and VDM (Vienna Development Method).

“Users implementing the present invention” refers to departments or individuals involved in respective phases.

For example, in the manufacturing industry, such users may include finished product manufacturers, component manufacturers, OEM (Original Equipment Manufacturing) companies, suppliers of components, materials, or software, software companies, logistics providers, and other related entities.

Such users may form a group consisting of two or more of these entities.

### Effects of the Invention

The present invention enables effective integrated configuration management across various phases and processes for items, including target products and components, while achieving high-precision bidirectional traceability.

Furthermore, the present invention optimizes combinations including requirements for item specifications, requirements for processes that fulfill the item specifications, approvals or disapprovals of such requirements, existence and scope of changes, and timing of such changes (hereinafter referred to as “instructions”).

In addition, the present invention enables systematic organization of management numbers through combinations of items, context, and instructions.

### BRIEF DESCRIPTION OF THE DRAWINGS

FIG. 1 is a conceptual diagram illustrating an information management device according to an embodiment of the present invention.

FIG. 2 is a diagram illustrating a system configuration of the information management device.

FIG. 3 is an example of a software screen executed by the information management device.

FIG. 4A is an example of a model created using the software.

FIG. 4B is an example of a model created using the software.

FIG. 4C is an example of a model created using the software.

FIG. 5 is an example of a model created using the software.

FIG. 6 is an example of a model created using the software.

FIG. 7 is an example of a model created using the software.

FIG. 8 is an example of a model created using the software.

FIG. 9 is an example of a model created using the software.

FIG. 10A is an example of a model created using the software.

FIG. 10B is an example of a model created using the software.

FIG. 11A is an example of a model created using the software.

FIG. 11B is an example of a model created using the software.

FIG. 11C is an example of a model created using the software.

FIG. 12A is an example of a model created using the software.

FIG. 12B is an example of a model created using the software.

FIG. 13A is an example of a model created using the software.

FIG. 13B is an example of a model created using the software.

FIG. 14 is a diagram illustrating a basic execution flow of the information management device.

FIG. 15 is a conceptual diagram illustrating a conventional information management device.

### DESCRIPTION OF EMBODIMENTS

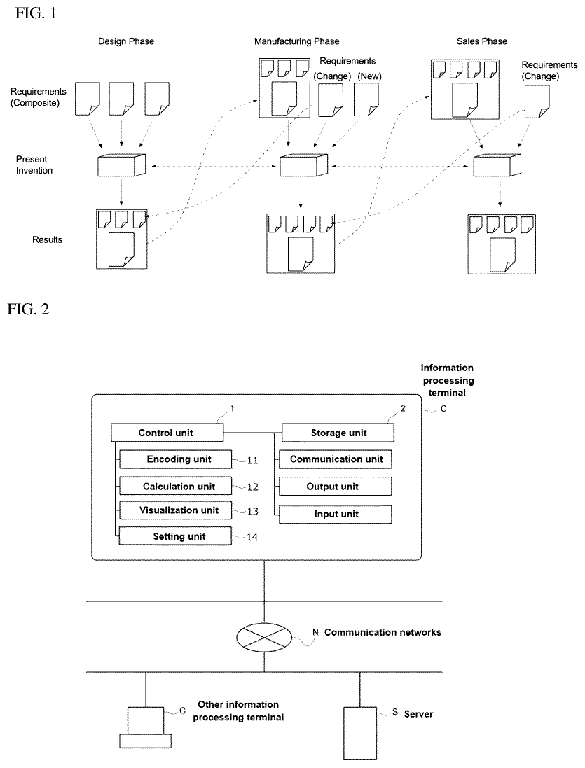

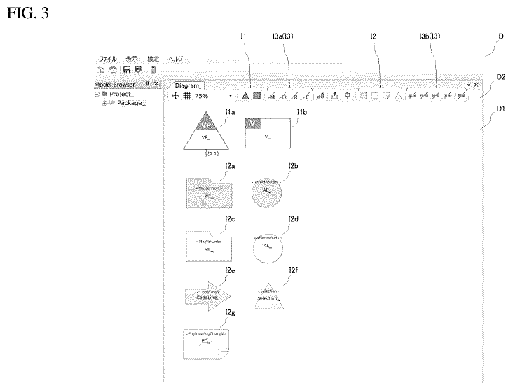

An example of an information management device according to an embodiment of the present invention will be described below with reference to FIGS. 1 and 2.

An overview of the information management device is as follows.

The information management device of the present invention combines Bills of Materials (BOMs) corresponding to patterns of items, processes, and instructions required from product planning and design to manufacturing and sales in the manufacturing industry.

The information management device enables users involved in products to flexibly combine such patterns and share suitable solutions as combinations.

This facilitates evaluation of selections and quality of solutions, as well as modification thereof.

Accordingly, the information management device enables integrated configuration management in the manufacturing industry, dynamic management of operational states in each phase of a product, bidirectional traceability of the product, adjustment of constraints for combinations, and establishment of a simplified numbering system based on such combinations.

As a result, quality of the product can be improved.

Items include, for example, in the case of automobiles manufactured in the manufacturing industry, materials derived from specified raw materials, components formed from the materials, parts such as engines, bodies, and ECUs (Electronic Control Units) obtained by processing or assembling the components, and finished products such as automobiles assembled from the parts.

Items also include raw materials, materials, components, parts, programs, software packages, drawings, consumables, and jigs used in a flow until a finished product is distributed in a market.

Items may further include finished products or components other than automobiles in the manufacturing industry, as well as services commercialized in non-manufacturing industries.

Processes include work, steps, tasks, routes, and selections as described above.

Basic hardware and software constituting the information management device are as follows.

The information management device is a computer system composed of one or more computers configured to process electronic information, including an operating system (OS), middleware, firmware, applications, other software, programs for executing such software, and data such as text, still images, videos, and audio.

The computer system includes a microprocessor having a CPU (Central Processing Unit) configured to perform arithmetic operations on electronic information and to control various hardware components.

The hardware components include auxiliary storage devices such as hard disk drives and SSDs for storing electronic information; temporary storage devices for temporarily storing electronic information during operations controlled by the CPU; communication devices such as RF chips, baseband chips, and other communication modules; input devices including keyboards, mice, touch panels, microphones, cameras, voice recorders, and sensors; output devices including displays, printers, speakers, and headphones; power supply devices such as batteries; and drive devices such as motors.

These hardware components may be appropriately combined to constitute the device, and each hardware component may be interconnected with other hardware components via input/output interfaces such as buses and/or USB ports.

The computer functions as an information processing terminal and may include, for example, personal computers, smartphones, and tablets.

Hardware and software configurations, including types, quantities, and sizes, may be determined according to applications and specifications, and may include configurations using quantum computers.

A plurality of computers may be interconnected via communication networks through input/output interfaces or communication devices, and other connection methods may also be employed.

Examples of the communication networks include the Internet, intranet, extranet, LAN, CATV networks, VPNs, telephone networks, mobile communication networks, and satellite communication networks.

Transmission media in such communication networks may include wired media such as IEEE 1394, power line communication, and telephone lines, as well as wireless media such as IrDA, Bluetooth® (registered trademark), IEEE 802.11 (Wi-Fi), mobile communication networks, satellite links, and terrestrial digital networks.

Each computer may exchange electronic information with other computers via such communication networks using communication devices.

Relationship between the information management device and hardware will be described.

As shown in FIG. 2, the information management device includes an information processing terminal C having a control unit 1 functioning as a microprocessor and a storage unit 2 functioning as auxiliary storage or temporary memory.

The information management device operates by executing software and programs stored in the storage unit 2 by the control unit 1.

The information management device may further include a communication unit (not shown) functioning as a communication device for transmitting and receiving electronic information to and from other information processing terminals, an output unit (not shown) functioning as an output device, and an input unit (not shown) functioning as an input device.

The information processing terminal C may communicate with a server device S via a communication network N, store electronic information in a storage unit of the server device S, and execute software or programs provided from the server device S by the control unit 1, which corresponds to an application service provider (ASP) model.

The control unit 1 includes an encoding unit 11 configured to encode various types of information, a calculation unit 12 configured to calculate solutions based on the encoded information, and a visualization unit 13 configured to visualize the encoded information.

The control unit 1 may further include a setting unit 14 configured to set constraints on the encoded information, a retrieval unit (not shown) configured to acquire information to be encoded via the input unit, and a display unit (not shown) configured to display the encoded and visualized information via the output unit.

The storage unit 2 may store:
encoded item information, context information, instruction information, dependency constraint information, and mutual relationship information;
visualized item information models, context information models, instruction information models, dependency constraint information models, and mutual relationship information models;
an OVM (Orthogonal Variability Model) modeler configured to describe item information, context information, instruction information, dependency constraint information, and mutual relationship information using an OVM;
software or programs including a solver configured to solve, as a combination problem using propositional logic expressions, configurations among item information, configurations among context information, configurations among instruction information, configurations between item information and context information, configurations between item information and instruction information, and configurations between context information and instruction information, based on mutual relationship information described by the OVM modeler; and
user information relating to users of the information management device.

The item information includes item basic information, item common identification information, and item non-common identification information as described above.

The context information includes process basic information, process common identification information, process non-common identification information, route information, and selection information as described above.

The instruction information includes arrangement information and chronological timing information as described above.

The dependency constraint information includes a parallel relationship, a dependency (requirement) relationship, a selection relationship, a mandatory relationship, an exclusive relationship, a membership relationship, an ownership relationship, a sharing relationship, a deriving relationship, and a realization relationship as described above.

An Orthogonal Variability Model (OVM) is a method for modeling variability information such as item information, context information, and instruction information.

The OVM models such information using variation point information (hereinafter also referred to as “variation points” or “VP”), which represents subjects of variation; variant information (hereinafter also referred to as “variants” or “V”), which represents contents of variation (instances of the variation points); and dependency constraint information specifying relationships among these elements.

Item information, context information, and instruction information may be treated as variation points or variants, or may be replaced with variation points or variants.

Dependency constraint information specifying configurations among variation points, among variants, or between variation points and variants may include a parallel relationship, a dependency relationship, a selection relationship, a mandatory relationship, and an exclusive relationship, as described above.

### <Details of Encoding Unit 11>

The encoding unit 11 includes:
a first encoding unit configured to encode item information;
a second encoding unit configured to encode context information;
a third encoding unit configured to encode instruction information;
a fourth encoding unit configured to encode dependency constraint information specifying configurations among item information, among context information, among instruction information, between item information and context information, between item information and instruction information, or between context information and instruction information; and
a fifth encoding unit configured to encode mutual relationship information representing relationships among item information, among context information, among instruction information, between item information and context information, between item information and instruction information, or between context information and instruction information, the relationships being established by the dependency constraint information.

The item information, context information, instruction information, and dependency constraint information to be encoded may be text data, image data, or audio data acquired by the retrieval unit.

The encoding unit 11 may execute an OVM (Orthogonal Variability Model) modeler to encode various types of information.

### <Details of Calculation Unit 12>

The calculation unit 12 is configured to calculate, based on encoded mutual relationship information, solutions of configurations among item information, among context information, among instruction information, between item information and context information, between item information and instruction information, and between context information and instruction information, as a combination problem using propositional logic expressions.

The calculation unit 12 may alternatively calculate the solutions by executing, for example, an ASP (Answer Set Programming) solver via an OVM modeler.

ASP is a paradigm that integrates concepts of logic programming and constraint programming and encodes programs including variables to compute sets of solutions for the encoded programs.

### <Details of Visualization Unit 13>

The visualization unit 13 is configured to visualize the calculated solutions for each combination as a list.

The visualization unit 13 includes:
a first visualization unit configured to visualize encoded item information as an item information model;
a second visualization unit configured to visualize encoded context information as a context information model;
a third visualization unit configured to visualize encoded instruction information as an instruction information model;
a fourth visualization unit configured to visualize encoded dependency constraint information as a dependency constraint information model; and
a fifth visualization unit configured to visualize encoded mutual relationship information as a mutual relationship information model.

The visualization unit 13 may execute an OVM (Orthogonal Variability Model) modeler to visualize the list and various types of information.

The first visualization unit is configured to extract icons from a first group of icons including two types of icons and/or from a second group of icons including two or more types of icons different from those of the first group, and to visualize the item information model.

The second visualization unit is configured to extract icons from the first group of icons and/or the second group of icons, and to visualize the context information model.

The third visualization unit is configured to extract icons from the first group of icons and/or the second group of icons, and to visualize the instruction information model.

The fourth visualization unit is configured to extract icons from a third group of icons, and to visualize the dependency constraint information model.

The first to fourth visualization units may execute an OVM (Orthogonal Variability Model) modeler to extract the first group of icons, the second group of icons, and the third group of icons.

The first group of icons includes icons having two types of shapes, such as triangles and squares.

The second group of icons may include icons that are visually distinguishable from each other, for example, by different shapes and/or colors, and may include icons corresponding to files, notes, circles, thick arrow lines, triangles, and other shapes used in flowcharts.

Each icon in the first group of icons and the second group of icons may have a corresponding meaning or name assigned thereto, and differences between the first group and the second group may be distinguished based on such meanings or names.

The third group of icons includes icons corresponding to thin arrow lines, and each icon in the third group may have a corresponding meaning or name assigned thereto.

### <Details of Setting Unit 14>

The setting unit 14 is configured to set constraint information contributing to constraint satisfaction for each combination of mutual relationship information corresponding to configurations among item information, among context information, among instruction information, between item information and context information, between item information and instruction information, and between context information and instruction information, and/or to set objective functions contributing to optimization of the configurations.

The setting unit 14 may provide the set constraint information and/or objective functions to the calculation unit 12.

The setting unit 14 may execute an OVM (Orthogonal Variability Model) modeler to perform setting of the constraint information and/or objective functions and provision thereof to the calculation unit 12.

### EXAMPLES

Next, the information management device will be described with reference to an operation screen of the OVM (Orthogonal Variability Model) modeler.

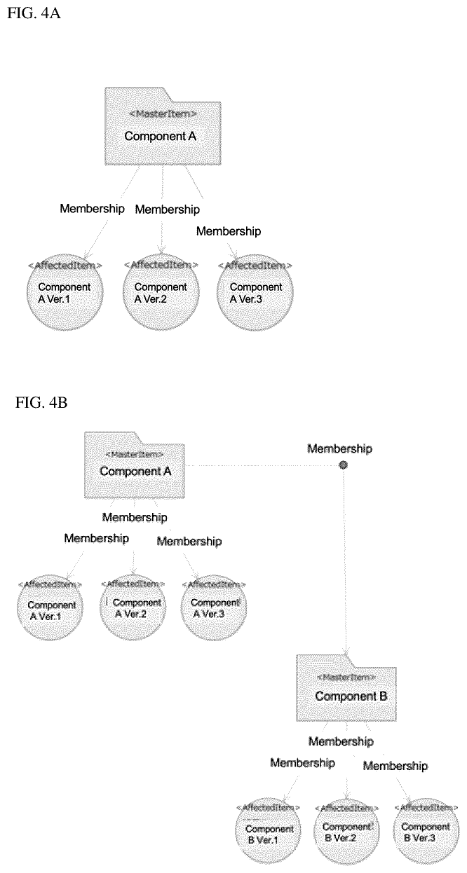

As shown in FIGS. 2 and 3, the information management device is implemented by the control unit 1 executing an OVM (Orthogonal Variability Model) modeler.

The control unit 1 starts the OVM modeler.

The control unit 1 displays an operation screen D including a description unit D1 for describing various types of information and an icon extraction unit D2 including a first icon group I1, a second icon group 12, and a third icon group 13.

The first icon group I1 includes an icon Ila representing variation point information, depicted as a triangle with “VP” displayed thereon, and an icon Ilb representing variant information, depicted as a square with “V” displayed thereon.

The second icon group 12 includes the following icons:
an icon I2a representing item common identification information (hereinafter referred to as “MasterItem”), depicted as a file with “MasterItem” displayed thereon;
an icon I2b representing item non-common identification information (hereinafter referred to as “AffectedItem”), depicted as a circle with “AffectedItem” displayed thereon;
an icon I2c representing process common identification information (hereinafter referred to as “MasterLink”), depicted as a file with “MasterLink” displayed thereon;
an icon I2d representing process non-common identification information (hereinafter referred to as “AffectedLink”), depicted as a circle with “AffectedLink” displayed thereon;
an icon I2e representing route information (hereinafter referred to as “CodeLine”), depicted as a thick arrow line with “CodeLine” displayed thereon;
an icon I2f representing selection information (hereinafter also referred to as “Selection” or “Choice”), depicted as a triangle with “Selection” displayed thereon; and
an icon I2g representing instruction information (hereinafter also referred to as “WorkItem” or “EngineeringChange”), depicted as a memo with “EngineeringChange” displayed thereon.

The third icon group 13 includes the following icons:
icons I3a, depicted as thin-lined arrows labeled “Mandates,” “Selects,” “Requires,” and “Exclusive,” representing mandatory, selection, dependency, and exclusive relationships that specify configurations among variation point information, among variant information, and between variation point information and variant information; and
icons I3b, depicted as thin-lined arrows labeled “Encompasses,” “Owns,” “Shares,” and “Derives,” representing membership, ownership, sharing, and deriving relationships that specify configurations among item information, among context information, among instruction information, between item information and context information, between item information and instruction information, and between context information and instruction information, and further including icons depicted as thin-lined arrows labeled “Realized by,” representing realization relationships that specify configurations between variant information and item information, context information, or instruction information, and between variation point information and item information, context information, or instruction information.

In the encoding unit 11, the first encoding unit is configured to select and encode item common identification information and/or item non-common identification information from item information.

The second encoding unit is configured to select and encode one or more of process common identification information, process non-common identification information, route information, and selection information from context information.

The third encoding unit is configured to encode instruction information.

The fourth encoding unit is configured to select and encode dependency constraint information specifying configurations of various types of information encoded by the first, second, and/or third encoding units.

The fifth encoding unit is configured to encode mutual relationship information of the various types of information established by the dependency constraint information.

The encoding unit 11 may further include a sixth encoding unit, a seventh encoding unit, and an eighth encoding unit.

The sixth encoding unit is configured to select and encode variation point information and variant information.

The seventh encoding unit is configured to select and encode dependency constraint information specifying configurations of the variation point information and variant information encoded by the sixth encoding unit.

The eighth encoding unit is configured to encode mutual relationship information of various types of information established by the dependency constraint information.

With this configuration, item common identification information, item non-common identification information, process common identification information, process non-common identification information, route information, selection information, and instruction information can be abstractly encoded by replacing them with variation point information and variant information.

The encoding unit 11 may further include a ninth encoding unit and a tenth encoding unit.

The ninth encoding unit is configured to select and encode a realization relationship as dependency constraint information in one of the following two configurations:
a first configuration in which variation point information encoded by the sixth encoding unit is associated with either item common identification information encoded by the first encoding unit, or process common identification information or selection information encoded by the second encoding unit; or
a second configuration in which variant information encoded by the sixth encoding unit is associated with any one of item common identification information or item non-common identification information encoded by the first encoding unit, process common identification information, process non-common identification information, route information, or selection information encoded by the second encoding unit, or instruction information encoded by the third encoding unit.

The tenth encoding unit is configured to encode mutual relationship information of various types of information established by the realization relationship.

With this configuration, realization relationships between two groups can be clearly represented, one group including variation point information and variant information encoded in an abstract manner, and the other group including item common identification information, item non-common identification information, process common identification information, process non-common identification information, route information, selection information, and instruction information encoded in a concrete manner.

Accordingly, it is possible to increase variations of selectable options and improve accuracy of solutions for configurations.

In the visualization unit 13, the first visualization unit is configured to visualize encoded item common identification information as an item common identification information model using an icon 12a, and encoded item non-common identification information as an item non-common identification information model using an icon I2b.

The second visualization unit is configured to visualize encoded process common identification information as a process common identification information model using an icon I2c, encoded process non-common identification information as a process non-common identification information model using an icon I2d, encoded route information as a route information model using an icon I2e, and encoded selection information as a selection information model using an icon I2f.

The third visualization unit is configured to visualize instruction information as an instruction information model using an icon 12g.

The fourth visualization unit is configured to visualize encoded membership relationships, ownership relationships, sharing relationships, and deriving relationships as a membership relationship model, an ownership relationship model, a sharing relationship model, and a deriving relationship model, respectively, using an icon I3b.

The fifth visualization unit is configured to visualize mutual relationship information as a mutual relationship information model based on the various models visualized by the first, second, third, and fourth visualization units.

The visualization unit 13 may further include a sixth visualization unit, a seventh visualization unit, and an eighth visualization unit.

The sixth visualization unit is configured to visualize encoded variation point information as a variation point information model using an icon Ila, and encoded variant information as a variant information model using an icon I1b.

The seventh visualization unit is configured to visualize encoded mandatory relationships, selection relationships, dependency relationships, and exclusive relationships as a mandatory relationship model, a selection relationship model, a dependency relationship model, and an exclusive relationship model, respectively, using an icon I3a.

The eighth visualization unit is configured to visualize mutual relationship information as a mutual relationship information model based on various models visualized by the sixth and seventh visualization units.

The visualization unit 13 may further include a ninth visualization unit and a tenth visualization unit.

The ninth visualization unit is configured to visualize encoded realization relationships as realization relationship models using an icon I3b.

The tenth visualization unit is configured to visualize mutual relationship information as a mutual relationship information model based on:
a variation point information model or a variant information model visualized by the sixth visualization unit; and
one selected from the following:
(i) an item common identification information model or an item non-common identification information model visualized by the first visualization unit;
(ii) a process common identification information model, a process non-common identification information model, a route information model, or a selection information model visualized by the second visualization unit; or
(iii) an instruction information model visualized by the third visualization unit.

Next, dependency constraint information will be described with reference to Table 1, the dependency constraint information specifying relationships among variation point information “VP,” variant information “V,” item common identification information “MasterItem,” item non-common identification information “AffectedItem,” process common identification information “MasterLink,” process non-common identification information “AffectedLink,” route information “CodeLine,” selection information “Selection,” and instruction information “EngineeringChange.”

TABLE 1

| From/ | | | Master | Affected | Master | Affected | | | Engineering |
|---|---|---|---|---|---|---|---|---|---|
| To | VP | V | Item | Item | Link | Link | CodeLine | Selection | Change |
| VP | Requires/ | Requires/ | Realization | X | Realization | X | X | Realization | X |
| | Exclusive | Exclusive/ | | | | | | | |
| | | Mandatory/ | | | | | | | |
| | | Selection | | | | | | | |
| V | Requires/ | Requires/ | Realization | Realization | Realization | Realization | Realization | Realization | Realization |
| | Exclusive | Exclusive | | | | | | | |
| MasterItem | X | X | Membership | Membership | X | X | Membership | X | X |
| Affected | X | X | Ownership/ | Deriving | Ownership/ | X | X | X | X |
| Item | | | Share | | Share | | | | |
| MasterLink | X | X | X | X | Membership | Membership | Membership | X | X |
| Affected | X | X | Ownership/ | X | Ownership/ | Deriving | X | X | X |
| Link | | | Share | | Share | | | | |
| CodeLine | X | X | X | Membership | X | Membership | X | X | X |
| Selection | X | X | X | Share | X | Share | X | X | X |
| Engineering | X | X | X | Ownership | X | Ownership | Ownership | Ownership | Share |
| Change | | | | | | | | | |

Table 1 shows a vertical axis (From) representing a subject side and a horizontal axis (To) representing a side having a predetermined relationship with the subject.

Relationships described in the table indicate the presence of such relationships or the absence thereof indicated by “X” marks. However, the present invention is not limited thereto, and other relationships not described in the table may be present, or specific relationships may be present in place of the “X” marks.

For the element “VP,” another “VP” has a dependency or exclusive relationship therewith, and “V” has a dependency, exclusive, mandatory, or selection relationship therewith.

In other words, “VP” depends on or excludes another “VP,” and “V” is dependent, excluded, mandated, or selected.

For the element “V,” both “VP” and another “V” have a dependency or exclusive relationship therewith.

In other words, “V” depends on or excludes “VP” and another “V.”

For the element “VP,” “MasterItem,” “MasterLink,” and “Selection” have realization relationships therewith.

In other words, “VP” represents abstract descriptions, whereas “MasterItem,” “MasterLink,” and “Selection” represent concrete descriptions.

For the element “V,” “MasterItem,” “AffectedItem,” “MasterLink,” “AffectedLink,” “CodeLine,” “Selection,” and “EngineeringChange” have realization relationships therewith.

In other words, “V” represents abstract descriptions, whereas “MasterItem,” “AffectedItem,” “MasterLink,” “AffectedLink,” “CodeLine,” “Selection,” and “EngineeringChange” represent concrete descriptions.

For the element “MasterItem,” another “MasterItem,” “AffectedLink,” and “CodeLine” have membership relationships therewith.

In other words, “MasterItem” encompasses another “MasterItem,” “AffectedLink,” and “CodeLine.”

For the element “AffectedItem,” “MasterItem” and “MasterLink” have ownership or sharing relationships therewith, and another “AffectedItem” has a deriving relationship therewith.

In other words, “AffectedItem” owns or shares “MasterItem” and “MasterLink,” and derives another “AffectedItem.”

For the element “MasterLink,” another “MasterLink,” “AffectedLink,” and “CodeLine” have membership relationships therewith.

In other words, “MasterLink” encompasses another “MasterLink,” “AffectedLink,” and “CodeLine.”

For the element “AffectedLink,” “MasterItem” and “MasterLink” have ownership or sharing relationships therewith, and another “AffectedLink” has a deriving relationship therewith.

In other words, “AffectedLink” owns or shares “MasterItem” and “MasterLink,” and derives another “AffectedLink.”

For the element “CodeLine,” “AffectedItem” and “AffectedLink” have membership relationships therewith.

In other words, “CodeLine” encompasses “AffectedItem” and “AffectedLink.”

For the element “Selection,” “AffectedItem” and “AffectedLink” have sharing relationships therewith.

In other words, “Selection” shares “AffectedItem” and “AffectedLink.”

For the element “EngineeringChange,” “AffectedItem,” “AffectedLink,” “CodeLine,” and “Selection” have ownership relationships therewith, and another “EngineeringChange” has a sharing relationship therewith.

In other words, “EngineeringChange” owns “AffectedItem,” “AffectedLink,” “CodeLine,” and “Selection,” and shares another “EngineeringChange.”

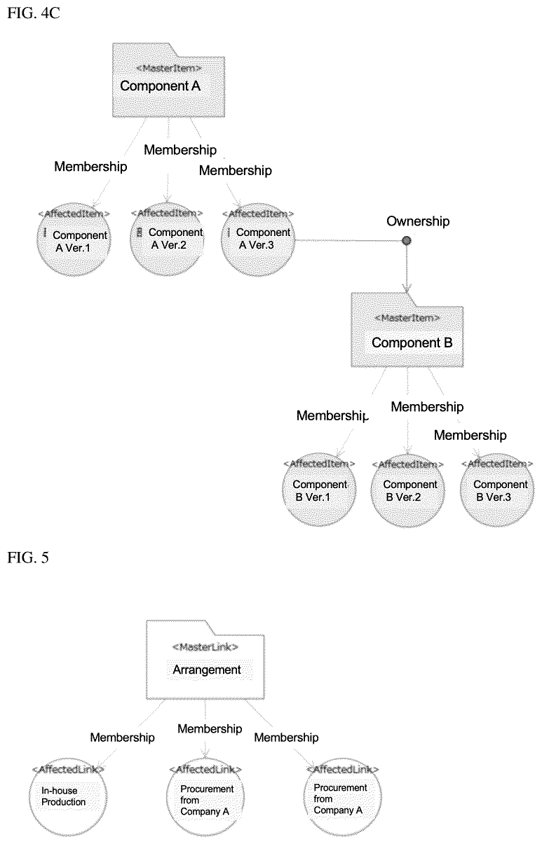

Next, examples of encoding and visualization of various types of information will be described with reference to FIGS. 4 to 12.

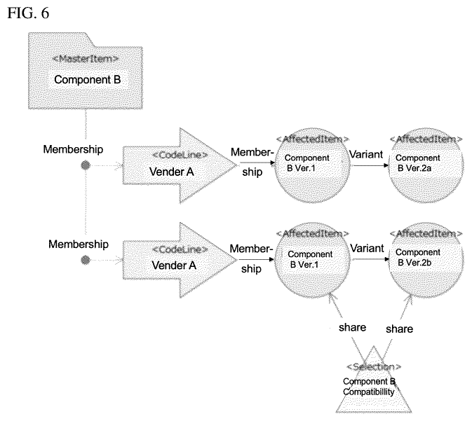

FIGS. 4A to 4C show basic configuration examples of “MasterItem” and “AffectedItem,” and FIG. 5 shows a basic configuration example of “MasterLink” and “AffectedLink.”

FIG. 4A illustrates encoding and visualization of relationships in which “MasterItem” is represented as a component A and “AffectedItem” is represented as versions 1 to 3 of the component A.

In this example, the component A encompasses versions 1 to 3 as its members.

According to this configuration, it is possible to encode and visualize item common identification information (e.g., component A), item non-common identification information (e.g., versions 1 to 3 of component A), and mutual relationship information determined by dependency constraint information specifying configurations of these elements.

Accordingly, it becomes easier to manage that versions 1 to 3 are selectable as component A.

FIG. 4B shows, in addition to FIG. 4A, encoding and visualization of relationships in which “MasterItem” is represented as component B and “AffectedItem” is represented as versions 1 to 3 of component B.

In this example, component B encompasses versions 1 to 3 as its members, and component A encompasses component B as its member.

According to this configuration, in addition to the effects described with reference to FIG. 4A, it is possible to encode and visualize mutual relationship information between item common identification information (e.g., component A and component B) and dependency constraint information specifying such configurations.

Accordingly, it becomes easier to manage that versions 1 to 3 of component B are also selectable as component A.

FIG. 4C shows a modified configuration of FIG. 4B in which version 3 of component A owns component B, and illustrates encoding and visualization of such relationships.

According to this configuration, it is possible to encode and visualize mutual relationship information determined by dependency constraint information specifying configurations (e.g., ownership relationships) between item non-common identification information (e.g., version 3 of component A) and item common identification information (e.g., component B).

Accordingly, it becomes easier to manage that versions 1 to 3 of component B are selectable as version 3 of component A.

FIG. 5 illustrates a configuration in which “MasterLink” is represented as an arrangement and “AffectedLink” is represented as specific members including in-house production, procurement from Company A, and procurement from Company B.

In this example, a membership relationship is encoded and visualized in which the members are either produced in-house or procured from Company A or Company B.

According to this configuration, it is possible to encode and visualize mutual relationship information determined by dependency constraint information (e.g., membership relationships) specifying configurations between process common identification information (e.g., arrangement) and process non-common identification information (e.g., in-house production, procurement from Company A, or procurement from Company B).

Accordingly, it becomes easier to manage that, as arrangements, in-house production or procurement from Company A or Company B are selectable options.

As is apparent from FIGS. 4A and 5, configuration examples of “MasterItem” and “AffectedItem” and configuration examples of “MasterLink” and “AffectedLink” differ only in the type of information.

Accordingly, “MasterLink” and “AffectedLink” can adopt configurations similar to those shown in FIGS. 4B and 4C.

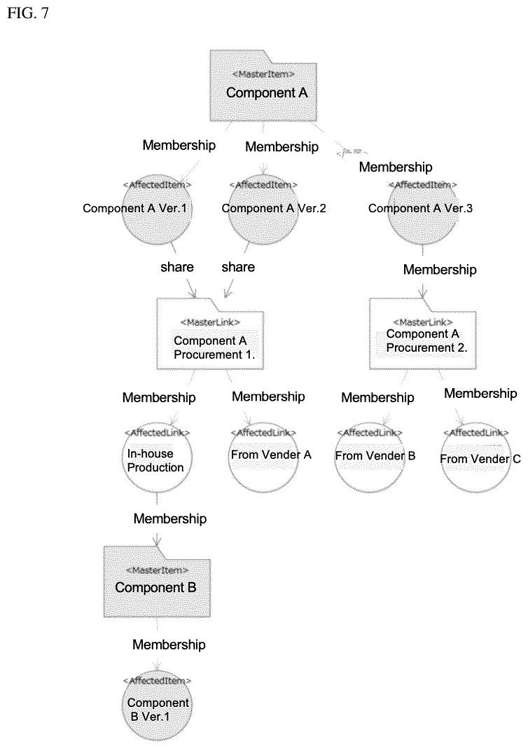

FIG. 6 shows a configuration example in which “MasterItem” and “AffectedItem” are combined with “CodeLine” and “Selection.”

FIG. 6 illustrates a configuration in which “MasterItem” is represented as component B, “AffectedItem” is represented as versions 1, 2a, and 2b of component B, “CodeLine” is represented as Manufacturer A and Manufacturer B, and “Selection” represents compatibility of component B.

In this configuration, component B encompasses versions 1, 2a, and 2b, Manufacturer A and Manufacturer B each include version 1 of component B as a member, version 1 derives versions 2a and 2b, and the selection shares versions 1 and 2b, indicating compatibility.

According to this configuration, it is possible to encode and visualize mutual relationship information by adding route information (e.g., Manufacturer A and Manufacturer B) and/or selection information (e.g., compatibility of component B) to configurations of item common identification information (e.g., component B) and item non-common identification information (e.g., versions 1, 2a, and 2b), together with dependency constraint information (e.g., membership and sharing relationships).

Accordingly, it becomes easier to manage that Manufacturer A and Manufacturer B are selectable as locations (e.g., manufacturing, storage, or transport destinations) for version 1 of component B and its derived versions 2a and 2b, and that versions 1 and 2b are selectable as compatible versions.

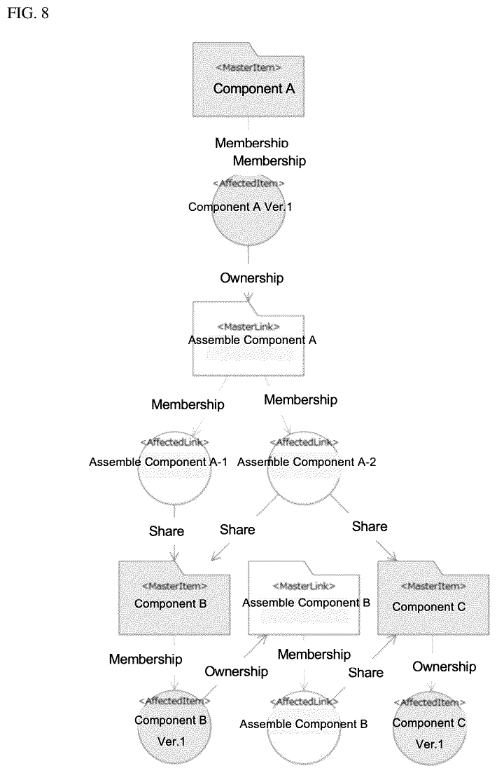

FIG. 7 shows a configuration example of an arrangement procedure using “MasterItem,” “AffectedItem,” “MasterLink,” and “AffectedLink.”

FIG. 7 illustrates a configuration in which “MasterItem” is represented as components A and B, “AffectedItem” is represented as versions 1 to 3 of component A and version 1 of component B, “MasterLink” is represented as arrangements 1 and 2 for component A, and “AffectedLink” is represented as in-house production and procurement from Companies A, B, and C.

In this configuration, component A encompasses versions 1 to 3, component B encompasses version 1, arrangement 1 encompasses in-house production and procurement from Company A, and arrangement 2 encompasses procurement from Companies B and C.

Further, versions 1 and 2 of component A share arrangement 1, version 3 of component A owns arrangement 2, and in-house production in arrangement 1 owns component B.

According to this configuration, item non-common identification information (e.g., versions 1 to 3 of component A) can be identified through process common identification information (e.g., arrangements 1 and 2) and corresponding process non-common identification information.

Further, process non-common identification information (e.g., in-house production) can be identified through item information of component B and its version.

Accordingly, it becomes easier to manage that versions 1 and 2 of component A may use arrangement 1, version 3 may use arrangement 2, and that when in-house production is selected, version 1 of component B is selected.

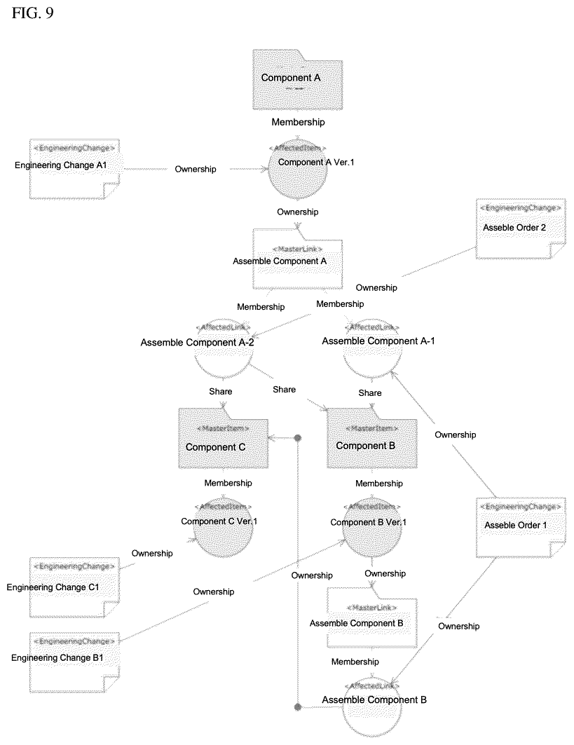

FIG. 8 shows a configuration example of an assembly procedure using “MasterItem,” “AffectedItem,” “MasterLink,” and “AffectedLink.”

FIG. 8 illustrates a configuration in which components A, B, and C each include version 1, assembly processes are defined for components A and B, and corresponding specific assembly processes are provided.

In this configuration, component A has two assembly processes, component B has one assembly process, version 1 of component A owns its assembly process, and assembly processes share components B and C depending on the selected process.

According to this configuration, item information and process information can be cross-referenced, and required components for each assembly process can be clearly identified.

Specifically, assembly process 1 requires version 1 of component B, whereas assembly process 2 requires both component B and component C.

Accordingly, management of required components for each assembly process is facilitated.

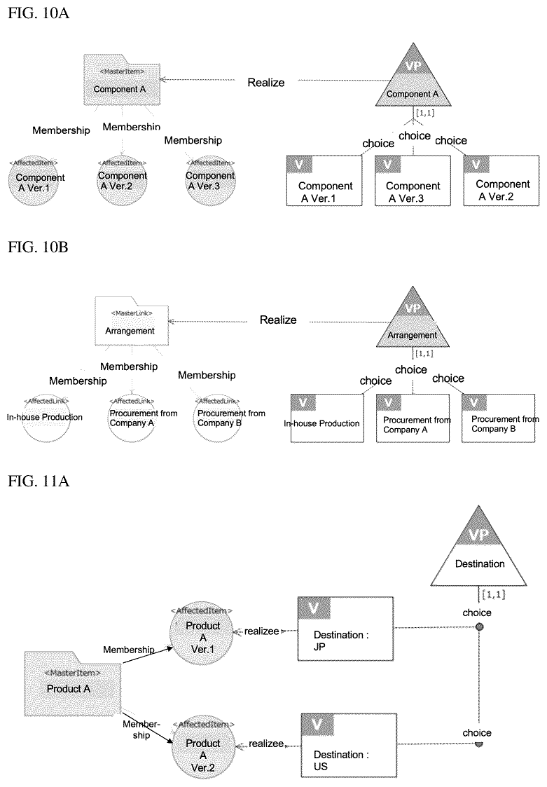

FIG. 9 shows a configuration example of an assembly procedure using “MasterItem,” “AffectedItem,” “MasterLink,” “AffectedLink,” and “EngineeringChange.”

FIG. 9 illustrates a configuration in which components A, B, and C are defined as “MasterItem,” version 1 of each component is defined as “AffectedItem,” assembly processes are defined as “MasterLink,” specific assembly processes are defined as “AffectedLink,” and engineering change instructions and assembly instructions are defined as “EngineeringChange.”

In this configuration, components A, B, and C each encompass version 1, the assembly of component A encompasses assembly 1 and assembly 2, and the assembly of component B encompasses its own assembly.

Further, version 1 of component A owns the assembly of component A, assembly 1 shares component B, assembly 2 shares components B and C, version 1 of component B owns the assembly of component B, and the assembly of component B shares component C.

Further, engineering change instructions A1, B1, and C1 own version 1 of components A, B, and C, respectively, assembly instruction 1 owns assembly 1 of component A and the assembly of component B, and assembly instruction 2 owns assembly 2 of component A.

In other words, the relationship shown in FIG. 3 with the addition of “EngineeringChange” is encoded and visualized.

According to this configuration, item information and process information can be mutually identified.

Further, item non-common identification information can be identified through process information, and process non-common identification information can be identified through item information.

Additionally, instruction information enables identification of both item information and process information.

Specifically, version 1 of component A may select either assembly process 1 or assembly process 2.

Assembly process 1 requires version 1 of component B pre-assembled with version 1 of component C, whereas assembly process 2 requires both version 1 of component B and version 1 of component C.

Further, versions 1 of components A to C follow engineering change instructions A1 to C1, respectively, assembly process 1 and the assembly of component B follow assembly instruction 1, and assembly process 2 follows assembly instruction 2.

Accordingly, management of assembly processes in relation to configurations and dependencies is facilitated.

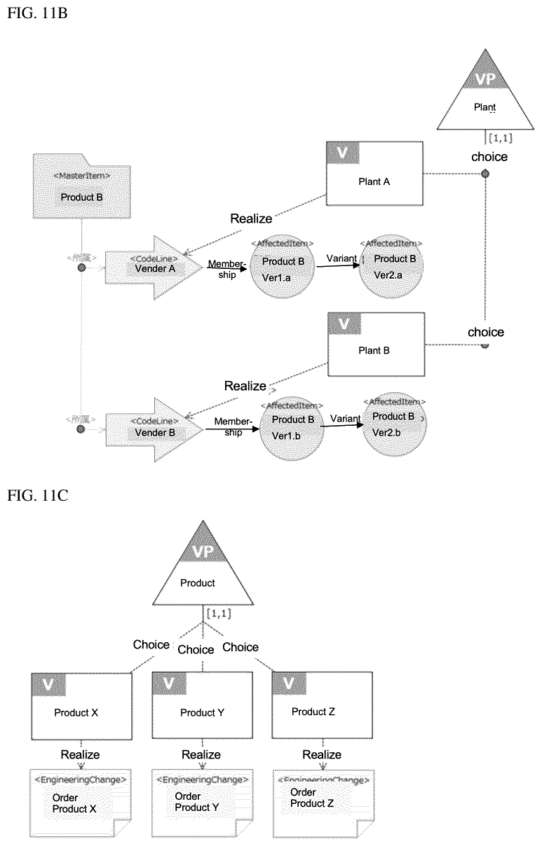

FIG. 10A illustrates relationships between the basic configuration example of “MasterItem” and “AffectedItem” shown in FIG. 4A and the basic configuration example of “VP” and “V.”

FIG. 10A illustrates encoding and visualization of:

a selection relationship in which “VP” represents component A and “V” represents versions 1 to 3 of component A; and

a realization relationship in which “VP” corresponding to component A is realized by “MasterItem” corresponding to component A.

According to this configuration, variation point information (e.g., component A) can be realized by item common identification information.

Accordingly, variation point information in the OVM model can be managed in a manner closer to actual business representation in a BOM model.

FIG. 10B illustrates relationships between the basic configuration example of “MasterLink” and “AffectedLink” shown in FIG. 5 and the basic configuration example of “VP” and “V.”

Except for differences in types of information, the contents are equivalent to those described with reference to FIG. 10A.

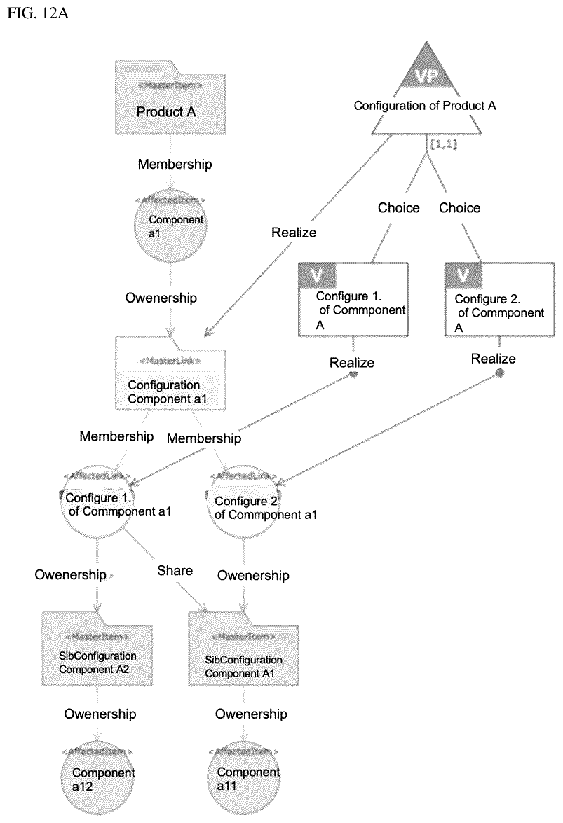

FIG. 11A illustrates relationships between another configuration example of “MasterItem” and “AffectedItem” and the basic configuration example of “VP” and “V” which is different from FIG. 10A,

FIG. 11A illustrates encoding and visualization of:
a selection relationship in which “VP” represents a destination and “V” represents Japan-bound and USA-bound options; and
a realization relationship in which Japan-bound and USA-bound variants are realized by versions 1 and 2 of product A in “AffectedItem.”

According to this configuration, variant information (e.g., Japan-bound and USA-bound) can be realized by item non-common identification information (e.g., versions 1 and 2 of product A).

Accordingly, variant information in the OVM model can be managed in a manner closer to actual business representation in a BOM model.

FIG. 11B illustrates relationships between the configuration example of “MasterItem,” “AffectedItem,” and “CodeLine” shown in FIG. 6 and the basic configuration example of “VP” and “V.”

FIG. 11B illustrates encoding and visualization of:
a selection relationship in which “VP” represents a factory and “V” represents Factory A and Factory B; and
a realization relationship in which Factory A and Factory B of “V” are realized by Manufacturer A and Manufacturer B in “CodeLine.”

According to this configuration, variant information (e.g., Factory A and Factory B) can be realized as route information (e.g., Manufacturer A and Manufacturer B).

Accordingly, variant information in the OVM model can be managed in a manner closer to actual business operations, such as order placement, in a BOM model.

FIG. 11C illustrates a basic configuration example of “VP” and “V” and relationships thereof with “EngineeringChange.”

FIG. 11C illustrates encoding and visualization of:
a selection relationship in which “VP” represents a product and “V” represents products X, Y, and Z; and
a realization relationship in which products X to Z of “V” are realized by manufacturing instructions X to Z of “EngineeringChange,” respectively.

According to this configuration, variant information (e.g., products X to Z) can be realized as instruction information (e.g., manufacturing instructions X to Z).

Accordingly, variant information in the OVM model can be managed in a manner closer to actual business operations in a BOM model.

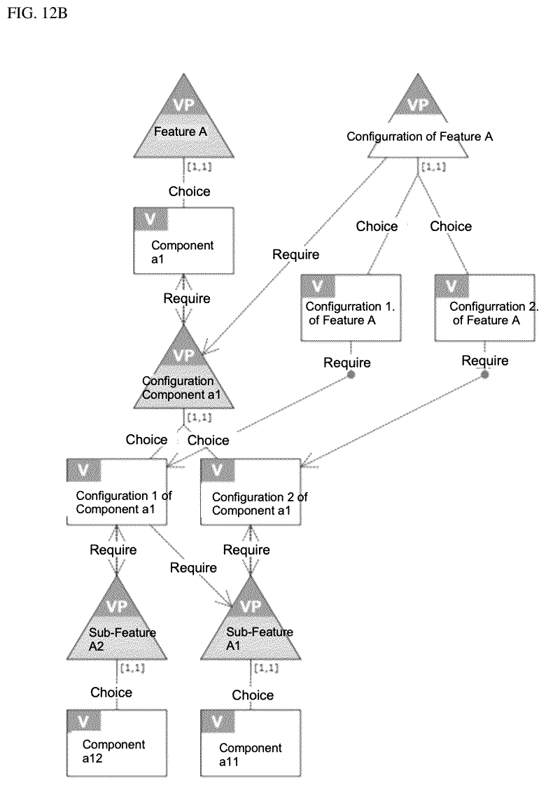

FIG. 12A illustrates a configuration example of a specification description using “MasterItem,” “AffectedItem,” “MasterLink,” “AffectedLink,” “VP,” and “V.”

Descriptions corresponding to those already explained with reference to FIGS. 4A to 11C are omitted as appropriate.

FIG. 12A illustrates encoding and visualization of relationships in which:
“MasterItem” represents function A, sub-function A1, and sub-function A2;
“AffectedItem” represents component a1, component a11, and component a12;
“MasterLink” represents a composition of component a1;
“AffectedLink” represents compositions 1 and 2 of component a1;
“VP” represents a component composition of function A; and
“V” represents component compositions 1 and 2 of function A.

In this configuration:
function A encompasses component a1, sub-function A1 encompasses component a11, and sub-function A2 encompasses component a12;
the composition of component a1 encompasses compositions 1 and 2;
component a1 owns its compositions;
composition 1 of component a1 owns sub-function A2 or shares sub-function A1;
composition 2 of component a1 owns sub-function A1;
the component composition of function A is realized by the composition of component a1;
component composition 1 of function A is realized by composition 1 of component a1; and
component composition 2 of function A is realized by composition 2 of component a1.

According to this configuration, variation point information (e.g., a component composition of function A) can be realized as item common identification information, and variant information (e.g., component compositions 1 and 2 of function A) can be realized as item non-common identification information.

Accordingly, component compositions represented as variation point and variant information in the OVM model can be managed in a manner closer to actual business operations in a BOM model.

FIG. 12B illustrates a configuration obtained by abstracting the configuration of FIG. 12A as shown in FIGS. 10A and 10B.

Specifically, in FIG. 12B:
“MasterItem” and “MasterLink” are replaced with “VP”;
“AffectedItem” and “AffectedLink” are replaced with “V”;
membership relationships are converted into selection relationships; and
ownership and sharing relationships are converted into dependency relationships.

According to this configuration, a BOM model can be converted into an OVM model and encoded, and solutions for configurations based on various types of information described in the BOM model can be calculated using a solver of the OVM modeler.

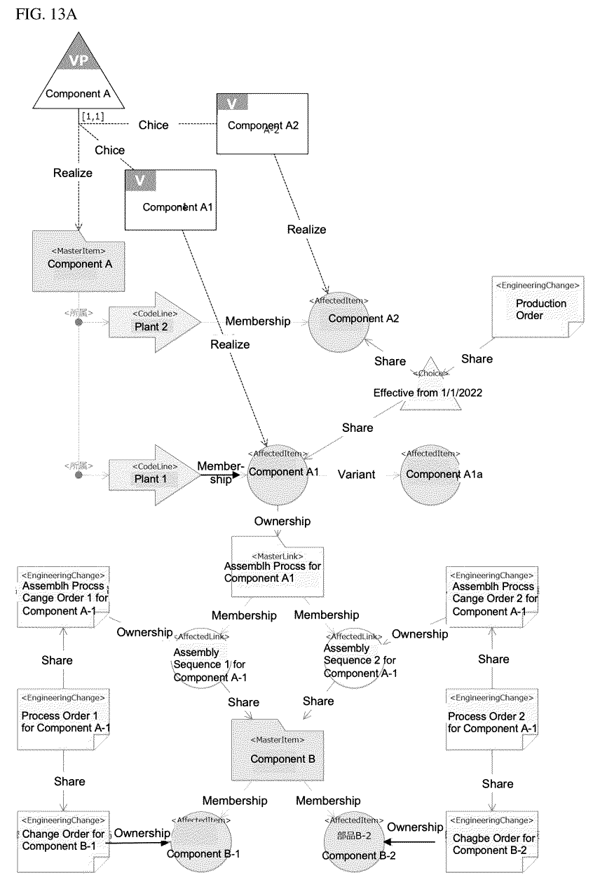

FIG. 13A illustrates an example of a combination information model created based on various types of information, and FIG. 13B illustrates solutions of the model.

As shown in FIG. 13A, “VP” represents component A, and “V” having a selection relationship with “VP” represents component A-1 and component A-2.

Thus, component A is defined as having two variants, component A-1 and component A-2.

However, modeling using only “VP” and “V” is insufficient to fully represent combination information. Therefore, combination information can be more effectively described by combining these with other types of information.

Details of such description are explained below.

First, “VP” representing component A is realized as “MasterItem,” and “V” representing component A-1 and component A-2 is realized as “AffectedItem.”

Further, the “MasterItem” of component A encompasses the “AffectedItem” of component A-1 via a “CodeLine” representing a first factory, and encompasses the “AffectedItem” of component A-2 via a “CodeLine” representing a second factory.

Accordingly, it becomes possible to represent that component A-1 is manufactured at the first factory and component A-2 is manufactured at the second factory.

Next, an “EngineeringChange” representing a manufacturing instruction owns a change (e.g., effective from Jan. 1, 2022) represented by “Selection,” and the change is shared by “AffectedItem” corresponding to component A-1 and component A-2.

Accordingly, it becomes possible to represent that the manufacturing instruction is effective from a specified date and applies to both component A-1 and component A-2.

Additionally, “AffectedItem” corresponding to component A-1 derives another “AffectedItem” corresponding to component A-la.

Accordingly, it becomes possible to represent that component A-la is derived from component A-1 with differences in specifications.

Additionally, component A-1 represented by “AffectedItem” owns an assembly process represented by “MasterLink,” and the assembly process encompasses assembly procedures 1 and 2 represented by “AffectedLink.”

Accordingly, it becomes possible to represent that the assembly process of component A-1 includes multiple assembly procedures.

Additionally, assembly procedures 1 and 2 represented by “AffectedLink” share component B represented by “MasterItem,” and component B encompasses component B-1 and component B-2 represented by “AffectedItem.”

Accordingly, it becomes possible to represent that assembly procedures may use either component B-1 or component B-2.

Additionally, two patterns exist for assembly instructions represented by “EngineeringChange.”

In a first pattern, the “EngineeringChange” shares an engineering change instruction for the assembly process of component A-1 and a specification change instruction for component B-1.

In a second pattern, the “EngineeringChange” shares an engineering change instruction for the assembly process of component A-1 and a specification change instruction for component B-2.

Accordingly, it becomes possible to represent that multiple configuration patterns exist depending on selected components and instructions.

Specifically, assembly procedures 1 and 2 follow corresponding assembly instructions, and each procedure uses component B-1 or B-2.

Further, each assembly instruction is associated with corresponding engineering change instructions and specification change instructions.

As shown in FIG. 13B, the calculation unit 12 calculates combinations of various options constituting the combination information model of FIG. 13A as solutions by using an ASP solver.

In FIG. 13B, “VP” represents a variation point with “V” as its variant, “MasterItem,” “Selection,” and “CodeLine” represent variation points with “AffectedItem” as their variants, and “MasterLink” represents a variation point with “AffectedLink” as its variant. “EngineeringChange” also represents a variation point with corresponding content as its variant.

Combinations of variation points and variants are listed as solutions 1 to 5, where “O” indicates a valid combination, “X” indicates an invalid combination, and “A” indicates a valid combination that does not satisfy certain related conditions.

When constraint information and objective functions are applied, the number of solutions may be reduced.

At this stage, specific correspondences are established, such that:
an engineering change instruction for a specification of component B-1 corresponds to component B-1;
an engineering change instruction for a specification of component B-2 corresponds to component B-2;
an engineering change instruction 1 for an assembly process of component A-1 corresponds to assembly 1; and
an engineering change instruction 2 corresponds to assembly 2.

Accordingly, the calculation unit 12 can reduce computational load by excluding unnecessary combinations and reflecting only relevant combinations in the solutions.

The setting unit 14 may set constraint information and objective functions prior to calculating solutions.

For example, attribute items such as price and evaluation may be defined, and variables (e.g., W1, W2) may be assigned.

Further, constraints may be set for minimum and maximum values of individual attribute values and their aggregated values, as well as objective functions.

Constraints may also be applied to attributes within dependency constraint information.

For example, constraint information may be set such that:
a calculated value of prices for components A-1, A-2, B-1, and B-2 does not exceed a specified value (e.g., 300).

Objective functions may be set such that:
a calculated value of evaluations for components A-1, A-2, B-1, and B-1 is maximized.

When multiple solutions satisfy the objective function, solutions may be selected based on additional criteria, such as minimizing or maximizing calculated values.

Constraint information may include:
a condition where a calculated value is less than or equal to a specified value;
a condition where a calculated value is greater than or equal to a specified value;
a condition where a calculated value is within a specified range;
a condition where an individual value is less than or equal to a specified value;
a condition where an individual value is greater than or equal to a specified value; and
a condition where an individual value is within a specified range.

Objective functions may include:
maximization;
minimization; and
extremization.

Accordingly, constraint information consists of six types, and objective functions consist of three types, enabling flexible configuration of combinations.

The following describes a basic execution flow of the information management device.

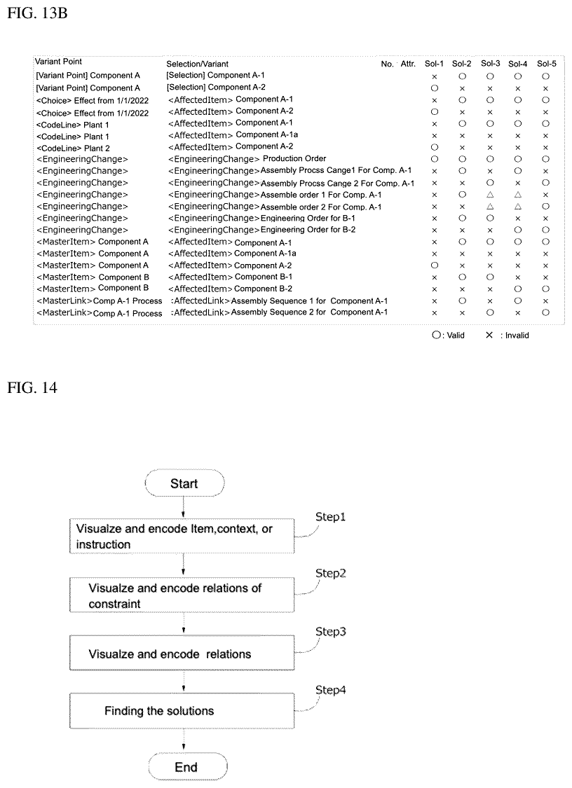

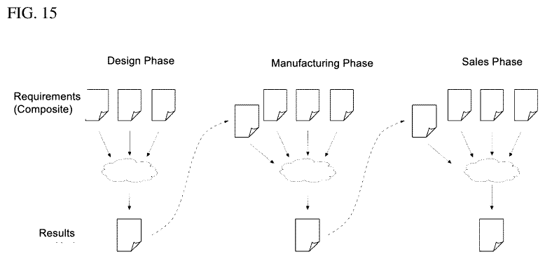

As shown in FIG. 14, the information management device executes the following steps:
(Step 1) Encoding and visualizing item information, context information, and instruction information;
(Step 2) Encoding and visualizing dependency constraint information specifying configurations and relationships;
(Step 3) Encoding and visualizing mutual relationship information based on dependency constraint information; and
(Step 4) calculating solutions for configurations using propositional logic expressions based on mutual relationship information.

According to this flow, integrated configuration management across multiple phases, from design to sales, can be achieved.

Further, dynamic management of operational states can be performed, including ECRS, ECM, and SCM.

Additionally, by associating relatively static item information and context information with dynamic instruction information such as sequence information and chronological timing information, constraints of mutual relationship information can be flexibly tightened or relaxed.

Further, constraints can be adjusted without modifying item information or context information by modifying instruction information.

Additionally, root cause analysis of defects or issues can be efficiently performed.

This is because appropriateness of processes in each phase can be evaluated in reverse order, from downstream to upstream, based on instruction information applied to items.

Additionally, by including item information, context information, and instruction information, and assigning selectable or occurring items in each phase to relationships among these types of information, it becomes possible to obtain an optimal combination for each phase.

Additionally, by standardizing a numbering system based on predetermined rules, management numbers can effectively convey requirements of departments and personnel in each phase while enabling a simplified numbering system.

For example, such management numbers include:
management numbers of item information used for identifying items, reflecting functionality and application of item specifications;
management numbers of context information, which are based on sequences or chronological timing defining operations; and
management numbers of instruction information, which are based on sequences or chronological timing related to instructions or approvals for executing or modifying operations.

Additionally, since a mutual relationship information model can be described by an item information model, a context information model, an instruction information model, and a dependency constraint information model, usability is improved and information processing efficiency is enhanced.

Finally, the present embodiment is not limited to the above-described configurations and encompasses any system, method, software, hardware, functions, and relationships thereof that achieve equivalent effects.

### REFERENCE SIGNS LIST

C: Information processing terminal
1: Control unit
11: Encoding unit
12: Calculation unit
13: Visualization unit
14: Setting unit
2: Storage unit
I1: First icon group
I2: Second icon group
I3: Third icon group
S: Server
N: Communication network

1. An information management device comprising:
an encoding unit configured to encode various types of information; and
a calculation unit configured to calculate solutions based on the encoded information,
wherein the encoding unit comprises:
a first encoding unit configured to encode item information for identifying items;
a second encoding unit configured to encode context information for identifying processes that change items from a predetermined state to another state;
a third encoding unit configured to encode instruction information relating to instructions or approvals for executing or modifying items and/or processes;
a fourth encoding unit configured to encode dependency constraint information specifying configurations among item information, among context information, among instruction information, between item information and context information, between item information and instruction information, or between context information and instruction information; and
a fifth encoding unit configured to encode mutual relationship information indicating relationships among item information, among context information, among instruction information, between item information and context information, between item information and instruction information, or between context information and instruction information, the relationships being established by the dependency constraint information,
wherein the calculation unit is configured to calculate solutions of configurations based on the encoded mutual relationship information using propositional logic expressions.

2. The information management device according to claim 1,
wherein the instruction information includes sequence information indicating a predetermined sequence and/or chronological timing information indicating time specified by year, month, day, hour, minute, and second, for identifying item information and/or context information.

3. The information management device according to claim 1,
wherein the item information includes item common identification information assigned for managing items, and item non-common identification information assigned for managing items based on the item common identification information;
the context information includes process common identification information assigned for managing processes, and process non-common identification information assigned for managing processes based on the process common identification information; and
the instruction information identifies the item non-common identification information and/or the process non-common identification information.

4. The information management device according to claim 1,
wherein the calculation unit is configured to calculate solutions of configurations by treating the mutual relationship information as a combination problem.

5. The information management device according to claim 4,
further comprising a visualization unit configured to visualize the encoded information,
wherein the visualization unit is configured to present the calculated solutions as a list of combinations.

6. The information management device according to claim 1,
further comprising a visualization unit configured to visualize the encoded information,
wherein the visualization unit comprises:
a first visualization unit configured to visualize the encoded item information as an item information model;
a second visualization unit configured to visualize the encoded context information as a context information model;
a third visualization unit configured to visualize the encoded instruction information as an instruction information model;
a fourth visualization unit configured to visualize the encoded dependency constraint information as a dependency constraint information model; and
a fifth visualization unit configured to visualize the encoded mutual relationship information as a mutual relationship information model.

7. The information management device according to claim 6,
wherein the first visualization unit is configured to extract icons from a first icon group including two types of icons and/or from a second icon group including two or more types of icons different from the first icon group to visualize the item information model;
the second visualization unit is configured to extract icons from the first icon group and/or the second icon group to visualize the context information model; and
the third visualization unit is configured to extract icons from the first icon group and/or the second icon group to visualize the instruction information model.

8. An information management method performed by a computer, comprising:
encoding item information for identifying items;
encoding context information for identifying processes that change items from a predetermined state to another state;
encoding instruction information relating to instructions or approvals for executing or modifying items and/or processes;
encoding dependency constraint information specifying configurations among item information, among context information, among instruction information, between item information and context information, between item information and instruction information, and/or between context information and instruction information;
encoding mutual relationship information representing relationships among item information, among context information, among instruction information, between item information and context information, between item information and instruction information, or between context information and instruction information, the relationships being established by the dependency constraint information; and
calculating solutions of configurations based on the encoded mutual relationship information using propositional logic expressions.

9. A non-transitory computer-readable medium storing a program that, when executed by a computer, causes the computer to perform a method comprising:
encoding item information for identifying items;
encoding context information for identifying processes that change items from a predetermined state to another state;
encoding instruction information relating to instructions or approvals for executing or modifying items and/or processes;
encoding dependency constraint information specifying configurations among item information, among context information, among instruction information, between item information and context information, between item information and instruction information, and/or between context information and instruction information;
encoding mutual relationship information representing relationships among item information, among context information, among instruction information, between item information and context information, between item information and instruction information, or between context information and instruction information, the relationships being established by the dependency constraint information; and
calculating solutions of configurations based on the encoded mutual relationship information using propositional logic expressions.
